(19) United States
(12) Patent Application Publication
(10) Pub. No.: US 2015/0299378 A1
(43) Pub. Date: Oct. 22, 2015

(54) CURABLE COMPOSITIONS

(71) Applicant: Dow Global Technologies LLC, Midland, MI (US)

(72) Inventors: Cuiping CHEN, Shanghai (CN); Yi Zhang, Wichita, KS (US); Wei Zhou, Shanghai (CN)

(73) Assignees: Dow Chemical (China) Investment Company Limited, Shanghai (CN); The Dow Chemical Company, Midland, MI (US)

(21) Appl. No.: 14/423,459

(22) PCT Filed: Oct. 31, 2012
(86) PCT No.: PCT/CN2012/083842

§ 371 Date: Feb. 24, 2015

(51) Int. Cl. C08G 59/14

(52) U.S. Cl. CPC C08G 59/14

(57) ABSTRACT

A curing agent composition including (a) at least one phenalkamine blended with (b) at least one styrenated phenol or styrenated phenol novolac compound to form a curing agent composition for an epoxy compound; a curable resin composition including (I) at least one epoxy compound; and (II) at least one phenalkamine blended with (III) at least one styrenated phenol or styrenated phenol novolac compound; and a thermoset prepared from the above curable composition.

### FIELD

The present invention is related to a curing agent formulation or composition for epoxy resins including at least one modified cashew nutshell liquid hardener or phenalkamine; to a curable epoxy resin formulation or composition including the curing agent composition; and to a thermoset prepared from the curable composition or formulation.

### BACKGROUND

Epoxide compounds are known to be used with a curing agent and other additives to form a curable composition for various enduses. For example, in potting, infrastructure and hand lay-up composite applications, a curable composition for such enduses generally requires a high reactivity (for example, a time to peak of less than (<) 150 minutes) and a low-exotherm (for example, a temperature of <125° C.) at the curing stage of a process for curing an epoxy resin composition to achieve effective production of a resulting thermoset product. However, high exothermal release (for example, a temperature of greater than (>) 125° C.) during cross-linking of the epoxy resin composition or system induces several severe deleterious issues including: decomposition of the curable composition; and unacceptable shrinkage, residual stress and cracking of the resulting thermoset product.

Alkyl phenols for example nonyl phenol and octyl phenol are difficult to biodegrade and are now strictly controlled due to the risk of the leakage to the environment. Cashew nutshell liquid (CNSL), a natural and renewable resource abstracted from cashew nutshell, is readily biodegradable (for example, 96% after 28 days when tested using OECD Method 302D, as referenced in a report found at the following website: www.epa.gov/hpv/pubs/summaries/casntliq/c13793tp.pdf of the U.S. Environmental Protection Agency); and can benefit the epoxy resin applications that are exposed to the environment.

Several curable compositions including an epoxy resin compound and a phenalkamine are known in the art and disclosed for example in US20070032575A1, WO2000001659, KR514100B1, US20110020555A1, US20100286345A1, DE602008005420D1 and WO2009141438. However, the above references do not disclose the required reactivity and low-exotherm when curing an epoxy resin composition to achieve effective production of a resulting thermoset product without the above-mentioned problems.

In addition, it is known to use amine hardeners with a specific chemical structure for curing epoxy resins, More particularly, it is known to use phenalkamines with epoxy resin compositions such as disclosed in US20100048827A1, US20110020555A1, and JP2004244430A. However, none of the above references disclose a Mannich base amine or phenalkamine having a specific structure in combination with a phenol compound without an amino group that achieves the required reactivity and low-exothenn when curing an epoxy resin composition without the problems of the prior art.

WO2011059500 discloses a curable composition that comprises: (a) a resin component and (b) a hardener component that includes an adduct and a Mannich base. The Mannich base is formed from a reaction of formaldehyde, a phenol compound, and a second amine. A styrenated phenol is listed as optional component as a non-reactive modifier. WO2011059500 does not disclose a phenalkamine as amine hardener and a styrenated phenol as accelerator to achieve low exotherm while maintaining a fast reactivity of the composition.

WO2006005723A1 discloses special amine compositions including (a) a polyetherdiamine, (b) a monoamine; and (c) a di- or tri-amine; and (d) an alkyphenol such as styrenated phenol. WO2006005723A1 also discloses that the amine compositions can be fonnulated with fast curing agents, such as Mannich bases.

JP57008221A provides an epoxy resin composition including (I) an epoxy resin; (II) a liquid styrenated phenol as a diluent; and (III) an amine curing agent. The amine curing agent includes aliphatic or aromatic polyamines, hydroxypolyamines, and polyamides. The Mannich base is produced by an amine, a phenol and an aldehyde. The liquid styrenated phenol has excellent compatibility with the epoxy resin, and reduces the viscosity of the epoxy resins without affecting the epoxy resins' mechanical properties, weatherability, and adhesive property. However, JP57008221A does not disclose the use of a CNSL-based phenalkamine as an amine composition and a liquid styrenated phenol as an accelerator in a curing agent; or wherein the curing agent provides low exotherm (<125° C.) performance.

US20100048827A1 discloses an amine composition comprising (a) N, N′-dimethyl-meta-xylylenediamine (DM-MXDA); (b) at least one multifunctional amine having 3 or more active amine hydrogen (for example, Cardolite Corporation NC-541LV); and (c) optionally, at least one plasticizer or solvent (for example, benzyl alcohol, cresol, bisphenol-A, cashew nutshell liquid, nonyl phenol,T-butyl phenol and phenols). The synthesis method of DM-MXDA, and also the related epoxy-amine coating indicated good anti-blushing performance.

US20110020555A1 disclosed a two-component epoxy resin compositions are capable of faster cure at low ambient temperatures to quickly form non-sticky coatings and seals having a good appearance. The curing agent component is selected from phenalkamines. Preferably, the phenalkamines are prepared with cardanol, such as Cardolite™ 540, 541, and 541LV phenalkamine hardeners, are preferred. The two-component epoxy resin compositions are capable of faster cure at low ambient temperatures, such as at temperatures below 10° C., below 50° C. or even below 0° C. to quickly form non-sticky coatings and seals having a good appearance. Tertiary amines may be used in the amine hardener component as Lewis base catalysts to accelerate the co-reaction of secondary amines. Suitable tertiary amine compounds that can be included in the amine hardener component include substituted phenolic amines, such as 2,4,6-tris(dimethyl-aminomethyl)phenol and dimethylamino-methylphenol. The proportion of tertiary amine compound in the amine hardener component is typically no more than about 20 weight percent, based on the total weight of amines in the amine hardener component.

### SUMMARY

The present invention provides the epoxy industry with an epoxy resin system or epoxy curable formulation or composition which can be used to prepare thermoset resin products having a sufficiently low exothenn (for example, <125° C.) to process the composition more easily and more efficiently into thermoset resin products for use in a wide range of various applications and enduses. For example, the present invention includes a low exotherm with highly reactive curing agent for enduses such as for potting, infrastructure and composite applications.

While generally it is known to use various processes in an attempt to achieve a low-exotherm (for example, <125° C.) at the curing stage of a process for curing an epoxy resin composition including: (1) a filler/additive approach; (2) a solvent/diluent approach; and (3) an amine hardener with a specific structure approach; the approach used in the present invention to achieve a low-exotherm when curing an epoxy resin composition is an approach that relates to an amine hardener with a specific structure.

For example, one embodiment of the present invention is directed to a novel curing agent composition for epoxy resins, wherein the curing agent composition includes: (a) at least one phenalkamine blended with (b) at least a styrenated phenol or styrenated phenol novolac, to form a curing agent for an epoxy resin. The phenalkamine compound can be prepared by a Mannich reaction of cashew nutshell liquid (CNSL) with formaldehyde and a polyamine. The novel curing agent of the present invention indicates a low exotherm release peak temperature at ambient temperature (for example, at a temperature of 23±2° C.) while maintaining a high reactivity (for example, <150 minutes) as compared with other conventional curing agents. The styrenated phenol or styrenated phenol novolac can function in the epoxy resin composition as an accelerator or as a catalyst. The curing agent described herein can also be referred to interchangeably as a crosslinking agent or a hardener.

Another embodiment of the present invention is directed to a curable epoxy resin composition including (I) at least one epoxy compound; (II) at least one phenalkamine; and (III) at least one phenol or phenol novolac having at least one alpha-methylbenzyl or alpha,alpha-dimethylbenzyl substituent.

Still another embodiment of the present invention is directed to a thermoset prepared from the above curable composition.

Some of the advantages provided by the present invention include an overall good performance of epoxy systems in terms of low exothermal release (for example, <125° C.) to address the crack issue, and shrinkage while the reactivity (curing speed) is maintained at a reasonable rate such as within 150 minutes (time to peak).

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a graphical illustration showing peak temperature versus time to peak (reactivity) of an epoxy resin with different curing agents.

FIG. 2 is a graphical illustration showing an exothermal release test curve plotting time to peak versus peak temperature of different amine curing agents.

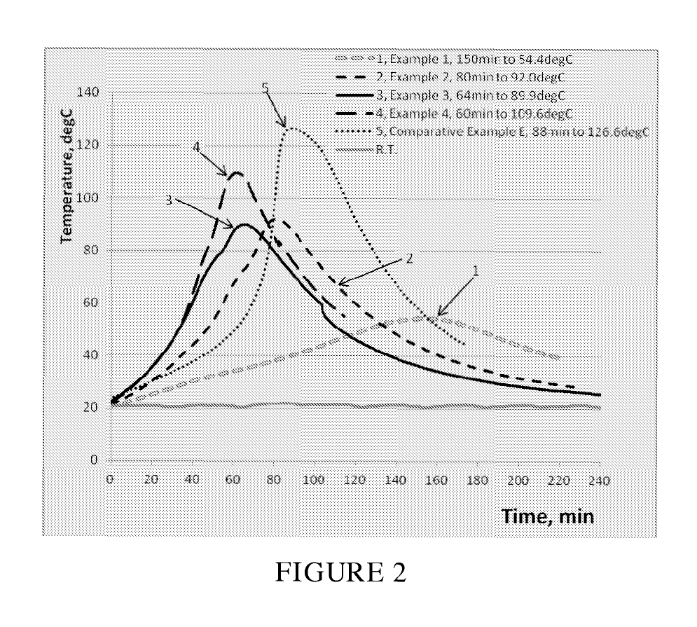

### DETAILED DESCRIPTION

“Low exotherm” with reference to curing a curable composition herein means a peak temperature below 125° C. as measured by a 100 g exotherm release test method.

“High reactivity” with reference to curing a curable composition herein means a time to peak within 150 minutes as measured by a 100 g exotherm release test method.

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International, and ISO refers to International Organization for Standards.

“And/or” means “and, or as an alternative”. All ranges include endpoints unless otherwise indicated.

In one broad embodiment, the present invention is directed to providing a curing agent formulation or composition including (a) at least one phenalkamine; and (b) at least one styrenated phenol or styrenated phenol novolac. The curing agent composition is advantageously used to cure an epoxy compound. Other optional additives known to the skilled artisan can be included in the curing agent composition such as for example an accelerator or a catalyst and other additives for various enduse applications.

The phenalkamine compound, useful as component (a) for preparing the curing agent composition of the present invention, may comprise for example any of the various phenalkamine compounds known in the art.

For example, the phenalkamine can be the result of the synthesis of a Mannich base curing agent essentially requiring cashew nutshell liquid (CNSL), formaldehyde, and a polyamine. Optionally, solvents such as benzene, toluene, or xylene can be used during the synthesis of the Mannich base curing agent. Generally, the optional solvent may be used for removing water produced under the azeotropic boiling point. Nitrogen may also be used for facilitating water removal in the above synthesis.

The formaldehyde can be a fonnalin solution, paraformaldehyde, or any substituted aldehyde. The polyamine can be aliphatic, cycloaliphatic, aromatic, polycyclic, or mixtures thereof. Examples of the polyamine useful in the present invention may include ethylenediamine (EDA); diethylenetriamine (DETA); triethylenetetramine (TETA); tetraethylenepentamine (TEPA); N-amino ethylpiperazine (N-AEP); isophorone diamine (1PDA); 1,3-cyclohexanebis(methylamine) (1,3-BAC); 4,4′-methylenebis(cyclohexylamine) (PACM); m-xylylenediamine (MXDA); or mixtures thereof.

The initial molar ratio of CNSL:aldehyde:polyamine for the Mannich base hardener synthesis can vary in the range of 1.0:1.0-3.0:1.0-3.0, and preferably 1.0:2.0-2.4:2.0-2.2. The Mamiich base hardener produced by employing a cashew nutshell liquid (mainly composing of cardanol and cardol when treated to decarboxylate) is specifically referred to herein as a phenalkamine curing agent.

A more preferred embodiment of the present invention includes for example a phenalkamine compound defined by Structure (I) as follows:

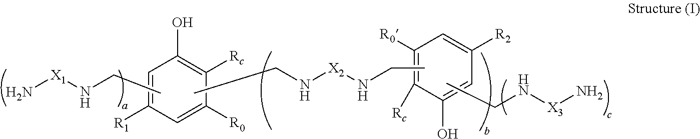

The modified cashew nutshell liquid (CNSL) hardener, or phenalkamine, has a general structure described above with reference to Structure (I). In Structure (I), R₀ and R₀′ each can be a straight alkyl with 15 carbons and 0 to 3 C═C bond(s) such as for example —C₁₅H₃₁, —C₁₅H₂₉, —C₁₅H₂₇, or —C₁₅H₂₅, or a straight alkyl with 17 carbons and 1 to 3 C═C bond(s) such as for example —C₁₇H₃₃, —C₁₇H₃₁, or —C₁₇H₂₉; R₁ and R₂ each can be hydrogen (—H) or hydroxyl (—OH); R_{c} can be hydrogen (—H) or carboxyl (—COOH); a can be 0 to 2; b can be 0 or a natural number ≦20; c can be 0 or 1; wherein a+b+c≠0; X₁, X₂, and X₃ each can be a bivalent or multivalent group having an ethylene aliphatic (—(CH₂)ₙ—), amino ethylene (—(NH(CH₂)m)n-), polyoxyalkylene,

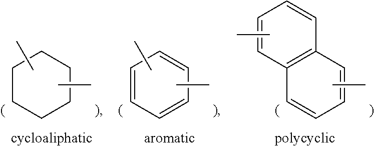

structure; and the like.

In one preferred embodiment, the phenalkamine or modified cashew nutshell liquid hardener useful in the present invention can be a polymer of cashew nutshell liquid with formaldehyde and ethylenediamine (for example, D.E.H. 641 and D.E.H. 642 available from The Dow Chemical Company). Modified cashew nutshell liquid hardeners or phenalkamines are also commercially available from Cardolite Corporation, such as for example NC-541LV, NC-541, LITE 2001LV, and LITE 201OLV; or commercially available from Paladin Paints and Chemicals Pvt. Ltd., such as for example PPA-7041-LV, and PPA-7041.

The concentration of the above described phenalkamine compound, as component (a), used in the curing agent composition of the present invention may range generally from about 10 weight percent (wt %) to about 99 wt % in one embodiment, from about 20 wt % to about 95 wt % in another embodiment, from about 30 wt % to about 90 wt % in still another embodiment, and from about 40 wt % to about 85 wt % in yet another embodiment, based on the weight of the curable agent composition.

The styrenated phenol or styrenated phenol novolac compound useful in the present invention for combining with the above phenalkamine to form a curing agent composition includes at least one phenol or phenol novolac having at least one alpha-methylbenzyl or alpha,alpha-dimethylbenzyl substituent, which generally was called as styrenated phenol or styrenated phenol novolac.

The styrenated phenol or styrenated phenol novolac compound may include two substances in which a phenol or phenol novolac has at least one alpha-methylbenzyl or alpha,alpha-dimethylbenzyl substituent. The alpha,alpha-dimethylbenzyl derivative also carries one or more t-butyl groups. The styrenated phenol or styrenated phenol novolac compound can be manufactured from phenol or phenol novolac by acid-catalyzed alkylation with styrene or alpha-methylstyrene. The t-butyl groups can be introduced by including isobutylene as a reactant

A more preferred embodiment of the styrenated phenol or styrenated phenol novolac of the present invention includes, for example, mono-styrenated phenol such as MSP-75 (commercially available from SI Group), and mixtures of mono-styrenated phenol, di-styrenated phenol, and tri-styrenated phenol such as SP-F and SP-24 (commercially available from Sanko Co. LTD).

The concentration of the above described styrenated phenol or styrenated phenol novolac, as component (b), used in the curing agent composition of the present invention may range generally from about I wt % to about 50 wt % in one embodiment, from about 2 wt % to about 40 wt % in another embodiment, from about 5 wt % to about 30 wt % in still another embodiment, and from about 10 wt % to about 30 wt % in yet another embodiment, based on the weight of the curable agent composition.

The present invention curing agent composition may include optional additives known to the skilled artisan that are not detrimental to the curing agent composition. For example, the curing agent composition can include an accelerator, a catalyst, or other additives required for various enduse applications.

In one preferred embodiment, at least one polyamine compound or a mixture of two or more polyamine compounds may optionally be used in combination with the phenalkamine and styrenated phenol or styrenated phenol novolac described above to form the curing agent composition. Examples of polyamines useful in the curing agent composition of the present invention may include an aliphatic polyamine, an alicyclic polyamine, an aromatic polyamine, a heterocyclic polyamine, and the like, and mixtures thereof.

The aliphatic polyamine useful in the present invention can include for example, an aliphatic diamine such as methylene diamine, ethylenediamine, 1,2-diaminopropane, 1,3-diaminopropane, 1,4-diaminobutane, 1,5-diamino pentane, 1,6-diamino hexane, 1,7-diamino heptane, 1,8-diamino octane, 1,9-diamino nonane, 1,10-diamino decane, o-xylylene diamine, m-xylylene diamine, p-xylylene diamine or mixtures thereof; a tetra-(aminomethyl)methane such as diethylenetriamine, dipropylene triamine, triethylenetetramine, tripropylene tetramine, tetraethylenepentamine, tetrapropylenepentamnine, penta ethylene hexamine, nonaethylene decamine; or mixtures thereof; a trimethyl hexamethylenediamine; tetrakis (2-amino ethyl aminomethyl)methane; an aliphatic triamine such as 1,3-bis(2′-amino ethyl amino)propane, triethylene -bis(trimethylene)hexamine, bis(3-amino ethyl)amine, bis-hexamethylene triamine or mixtures thereof; 1,4-cyclohexanediamine; 4,4′-methylene bis cyclohexylamine; an alicyclic diamine such as 4,4′-isopropylidene biscyclo hexylamine, norborna diamine, bis(aminomethyl)cyclohexane, diamino dicyclo hexylmethane, isophorone diamine, menthen diamine or mixtures thereof; bis(aminoalkyl)benzene; bis (aminoalkyl)naphthalene; bis(cyanoethyl)diethylenetriamine; phenylenediamine; naphtylene diamine; diamino diphenylmethane; diamino diethyl phenylmethane; 2,2-bis(4-aminophenyl)propane;4,4′-diamino diphenylether; 4,4′-diamino benzophenone; 4,4′-diamino diphenylether; 4,4′-diaminodiphenyl sulfone; a 2,2′-dimethyl-4,4′-diamino diphenylmethane; 2,4′-diamino biphenyl; 2,3′-dimethyl-4,4′-diamino biphenyl; 3,3′-dimethoxy-4,4′-diamino biphenyl; an aromatic diamine such as bis(aminomethyl)naphthalene, bis(amino ethyl)naphthalene or mixtures thereof; N -methyl piperazine; morpholine; 1,4-bis(8-aminopropyl)-piperazine; aheterocyclic diamine such as piperazine-1,4-diaza cycloheptane, 1-(T-amino ethyl piperazine), 1-[2′-(2″-amino ethyl amino)ethyl]piperazine, 1,11-diaza cyclo eicosane, 1,15-diaza cyclo octacosane, and the like, or mixtures thereof.

The concentration of the above described polyamine compound, as optional component (c), when used in the curing agent composition of the present invention may range generally from 0 wt % to about 50 wt % in one embodiment, from about 0.1 wt % to about 40 wt % in another embodiment, from about 1 wt % to about 30 wt % in still another embodiment, and from about 2 wt % to about 20 wt % in yet another embodiment, based on the weight of the curable composition.

Optionally, a diluent or solvent can be used in the curing agent composition of the present invention. For example, in a preferred embodiment, the curing agent composition of the present invention may include a diluent or a solvent such as for example cashew nutshell liquid; cardanol; nonyl phenol; ethers such as tetrahydrofuran, -1,2-dimethoxyethane, 1,2 diethoxy ethane or mixtures thereof; an alcohol such as an iso- or a normal-butanol, an amyl alcohol, benzyl alcohol, or furfuryl alcohol or mixtures thereof; an Aromatic hydrocarbon such as benzene, toluene, xylene or mixtures thereof; a ketone such as methyl isobutyl ketone, methyl ethyl ketone, or mixtures thereof; an ether such as ethylene dichloride, acrylonitrile, methyl tertiary butyl ether, propylene glycol monomethyl ether, or mixtures thereof; arrester such as ethyl acetate, butyl acetate, butyl cellosolve, or mixtures thereof; oil of turpentine; a terpene-hydrocarbon oil such as D-limonene, pinene, or mixtures thereof; a high boiling point paraffin type solvent such as a mineral spirit, Swasol #310 (made by Cosmo Matsuyama Petroleum Corporation Co., Ltd.|KK), Solvesso #100 (Exxon-Chemical Corporation Co., Ltd.IKK), and the like, or mixtures thereof.

The concentration of the above described diluent or solvent, as optional component (d), when used in the curing agent composition of the present invention may range generally from 0 wt % to about 40 wt % in one embodiment, from about 0.1 wt % to about 30 wt % in another embodiment, from about 1 wt % to about 20 wt % in still another embodiment, and from about 2 wt % to about 10 wt % in yet another embodiment, based on the weight of the curable composition.

Other optional compounds that may be added to the curable composition of the present invention may include compounds that are normally used in resin compositions known to those skilled in the art for preparing curable compositions and then nosets. For example, the optional components may comprise compounds that can be added to the composition to enhance application properties (for example, surface tension modifiers, flow aids, gas release agents, or colorants), reliability properties (for example, adhesion promoters), the reaction rate, the selectivity of the reaction, and/or the catalyst lifetime.

Optional compounds useful for the curable composition of the present invention may include, for example, a solvent to lower the viscosity of the composition further, other resins such as a phenolic resin that can be blended with the epoxy resin of the composition, other epoxy resins different from the epoxy compound of the present invention (for example, aromatic and aliphatic glycidyl ethers; cycloaliphatic epoxy resins; and divinylarene dioxides such as divinylbenzene dioxide), other curing agents, fillers, pigments, toughening agents, flow modifiers, adhesion promoters, diluents, stabilizers, plasticizers, catalyst de-activators, flame retardants, and mixtures thereof.

Generally, the amount of an optional components, when used in the curable composition of the present invention, may be for example, from 0 wt % to about 20 wt % in one embodiment, from about 0.01 wt % to about 18 wt % in another embodiment; from about 0.1 wt % to about 15 wt % in still another embodiment; and from about 1 wt % to about 10 wt % in yet another embodiment.

The preparation of modified cashew nutshell liquid (CNSL) hardener or phenalkamine essentially employs cashew nutshell liquid (commercially available from Huada Saigao [Yantai] Science & Technology Company Limited), formalin or paraformaldehyde, and a polyamine precursor of aliphatic, or polyoxyalkylene, or cycloaliphatic, or aromatic structure, or a mixture thereof. Examples of the aliphatic polyamine precursor may include ethylenediamine (EDA), diethylenetriamine (DETA), triethylenetetramine (TETA), tetraethylenepentamine (TEPA), pentaethylenehexamine (PEHA), N-aminoethylpiperazine (N-AEP) and mixtures thereof. The polyoxyalkylene precursor may include for example Jeffamine® D-230 and Jeffamine® D-400 commercially available from Huntsman Corporation. Examples of the cycloaliphatic polyamine precursor may include isophorone diamine (IPDA), 1,3-cyclohexanebis(methylamine) (1,3-BAC); 4,4′-methylenebis(cyclohexylamine) (PACM); and mixtures thereof. The aromatic polyamine precursor may include for example xylylenediamine (MXDA).

Benzene or xylene may also optionally be used in the above synthesis acting as a solvent to remove the water produced during the reaction at the azeotropic distillation point.

The initial molar ratio for the modified cashew nutshell liquid hardener synthesis can vary in the range of molar ratio that CNSL:aldehyde:polyamine can be for example 1.0:1.0-3.0:1.0-3.0 in one embodiment, and 1.0:2.0-2.4:2.0-2.2 in another embodiment. The CNSL used in the present invention can be of a crude grade, that is, the crude CNSL may contain mainly anacardic acid; or the CNSL may be of a treated grade, that is, the anacardic acid contained as a major component in CNSL may be converted to cardanol for example by decarboxylation.

The process for preparing the curing agent composition of the present invention includes admixing (a) at least one phenalkamine compound; and (b) at least one styrenated phenol or styrenated phenol novolac to form a curing agent composition which can then be used to cure an epoxy resin. Optionally, other optional ingredients are added to the curing agent composition mixture as needed. For example, the preparation of the curing agent composition of the present invention is achieved by blending, in known mixing equipment, the phenalkamine compound, the styrenated phenol or styrenated phenol novolac, and optionally any other desirable additives. Any of the above-mentioned optional additives may be added to the composition during the mixing or prior to the mixing to form the curing agent composition.

All the compounds of the curing agent composition are typically mixed and dispersed at a temperature enabling the preparation of an effective curing agent composition having the desired balance of properties for a particular application. For example, the temperature during the mixing of all components may be generally from about 0° C. to about 80° C. in one embodiment, and from about 15° C. to about 50° C. in another embodiment.

The preparation of the curing agent composition of the present invention, and/or any of the steps thereof, may be a batch or a continuous process. The mixing equipment used in the process may be any vessel and ancillary equipment well known to those skilled in the art.

The curing agent composition of the present invention produced as describe above exhibits excellent properties such as anti-blushing (or hydrophobicity). In addition, the curing agent composition of the present invention exhibits excellent properties such as low-exothenn peak temperature (<125° C.) and fast reactivity (<150 minutes). For example, the exotherm peak temperature of the writing agent composition of the present invention generally can be from about 55° C. to about 125° C. in one embodiment, from about 60° C. to about 115° C. in another embodiment, and from about 60° C. to about 105° C. in still another embodiment. For example, the reactivity time of the curable agent composition of the present invention generally can be from about 45 minutes to about 150 minutes in one embodiment, from about 50 minutes to about 145 minutes in another embodiment, and from about 55 minutes to about 140 minutes in still another embodiment.

Another embodiment of the present invention is directed to providing a curable resin formulation or composition including (I) at least one epoxy compound; (II) at least one phenalkamine; and (III) at least one styrenated phenol or styrenated phenol novolac compound. Other optional additives known to the skilled artisan can be included in the curable composition such as for example a curing catalyst and other additives for various enduse applications.

The epoxy compound or epoxide group-containing compound, that may be used in the curable resin composition and can be cured with the above curing agent composition (that is, the curing agent including (a) at least one phenalkamine; and (b) at least one styrenated phenol or styrenated phenol novolac), can be selected from any number of conventional epoxy compounds.

For example, the curable resin composition of the present invention may include at least one epoxy resin compound such as a liquid epoxy resin (LER) component (I) to fonn the epoxy matrix in a final curable composition. For example, the epoxide compound useful as component (I) in preparing a curable composition of the present invention may comprise a low viscosity epoxy resin compound. For example, the low viscosity epoxy resin compound useful in the present invention may include the divinylarene dioxide epoxy compounds described in U.S. Patent Application Publication No. 2011/0245434; incorporated herein by reference.

One embodiment of the epoxy compound used in the curable resin composition of the present invention, may be for example a single epoxy compound used alone; or a combination of two or more epoxy compounds known in the art such as any of the epoxy compounds described in Lee, H. and Neville, K., Handbook of Epoxy Resins, McGraw-Hill Book Company, New York, 1967, Chapter 2, pages 2-1 to 2-27, incorporated herein by reference.

In a preferred embodiment, the epoxy compound may include for example epoxy resins based on reaction products of polyfunctional alcohols, phenols, cycloaliphatic carboxylic acids, aromatic amines, or aminophenols with epichlorohydrin. A few non-limiting embodiments of the epoxy compound include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs. The epoxy compound may also be selected from commercially available epoxy resin products such as for example, D.E.R. 3318, D.E.R.332, D.E.R. 354, D.E.R. 580, D.E.N. 425, D.E.N. 431, D.E.N. 438, D.E.R. 736, or D.E.R. 732 epoxy resins available from The Dow Chemical Company.

In another embodiment, the “epoxide group-containing compound” useful as the epoxy compound component (I) of the curable resin composition of the present invention can include for example at least one reactive diluent which contains at least one epoxy group. The reactive diluents useful in the present invention may be saturated or unsaturated, aliphatic, cycloaliphatic, aromatic or heterocyclic and may be substituted. In one preferred embodiment, the reactive diluent may be aliphatic mono-glycidyl ether or di-glycidyl ether or tri-glycidyle ether. In another preferred embodiment, the reactive diluent may be 1,4-bis(2,3-epoxypropyloxy)butane (for example, ChemMod 67 available from PolyStar LLC); hexanediol diglycidyl ether (for example, ChemMod 69 available from PolyStar LLC); C12-C14 alkyl glycidyl ether (for example POLYPDX R24 available from The Dow Chemical Company); trimethylol propane-epichlorohydrin copolymer (for example POLYPDX R20 available from The Dow Chemical Company); and mixtures thereof.

Generally, the amount of the epoxy compound used in the curable composition of the present invention may be, for example, from 50 wt % to about 80 wt % in one embodiment, from about 51 wt % to about 75 wt % in another embodiment; from about 52 wt % to about 70 wt % in still another embodiment; and from about 53 wt % to about 65 wt % in yet another embodiment, based on the total weight of the composition.

The at least one phenalkamine compound useful in the curable epoxy resin composition, as component (II), can be any of the phenalkamine compounds described above.

Generally, the amount of the phenalkamine compound used in the curable resin composition of the present invention may be, for example, from 10 wt % to about 80 wt % in one embodiment, from about 15 wt % to about 70 wt % in another embodiment; from about 20 wt % to about 60 wt % in still another embodiment; and from about 30 wt % to about 50 wt % in yet another embodiment, based on the total weight of the composition.

The at least one styrenated phenol or styrenated phenol novolac compound useful in the curable epoxy resin composition, as component (III), can be any of the styrenated phenol or styrenated phenol novolac compounds described above.

Generally, the amount of the styrenated phenol or styrenated phenol novolac compound used in the curable composition of the present invention may be, for example, from 1 wt % to about 30 wt % in one embodiment, from about 2 wt % to about 20 wt % in another embodiment; from about 3 wt % to about 15 wt % in still another embodiment; and from about 3 wt % to about 13 wt % in yet another embodiment, based on the total weight of the composition.

Other optional compounds that may be added to the curable resin composition of the present invention may include compounds that are normally used in resin compositions known to those skilled in the art for preparing curable compositions and thermosets. For example, the optional components may comprise compounds that can be added to the composition to enhance application properties (for example surface tension modifiers, flow aids, gas release agents, or colorants), reliability properties (for example adhesion promoters), the reaction rate, the selectivity of the reaction, and/or the catalyst lifetime.

Other optional compounds that may be added to the curable composition of the present invention may include, for example, a solvent to lower the viscosity of the composition further, other resins such as a phenolic resin that can be blended with the epoxy resin of the composition, other epoxy resins different from the epoxy compound of the present invention (for example, aromatic and aliphatic glycidyl ethers; cycloaliphatic epoxy resins; and divinylarene dioxides such as divinylbenzene dioxide), other curing agents, fillers, pigments, toughening agents, flow modifiers, adhesion promoters, diluents, stabilizers, plasticizers, catalyst de-activators, flame retardants, and mixtures thereof.

Generally, the amount of other optional components, when used in the curable composition of the present invention, may be for example, from 0 wt % to about 20 wt % in one embodiment, from about 0.01 wt % to about 18 wt % in another embodiment; from about 0.1 wt % to about 15 wt % in still another embodiment; and from about 1 wt % to about 10 wt % in yet another embodiment.

The process for preparing the curable composition of the present invention includes admixing (I) at least one epoxide compound; (II) at least one phenalkamine; and (III) at least one styrenated phenol or styrenated phenol novolac compound described above to form the curable composition which can be cured to form a thermoset product. Optionally, other optional ingredients are added to the curable composition mixture as needed. For example, the preparation of the curable resin composition of the present invention may be achieved by blending, in known mixing equipment, the epoxy compound, the curing agent composition, and optionally any other desirable additives. Any of the above-mentioned optional additives may be added to the curable composition during the mixing or prior to the mixing to form the curable composition which is to be cured.

In one embodiment, the (I) at least one epoxide compound; (H) at least one phenalkamine; and (III) at least one styrenated phenol or styrenated phenol novolac compound can all be admixed together in a mixing vessel. In another preferred embodiment of the present invention, the curable composition may be produced by mixing one or more of the compounds (I)-(III) as a “Side A” composition with one or more of the compounds (I)-(III) as a “Side B” composition. For example, Side A may contain the epoxy compound blended with the styrenated phenol or styrenated phenol novolac compound and/or other optional additives; and Side B may generally contain the phenalkamine hardener. In another embodiment, Side B in addition to the phenalkamine hardener may contain a styrenated phenol or styrenated phenol novolac compound and/or other optional additives.

All the compounds of the curable composition are typically mixed and dispersed at a temperature enabling the preparation of an effective curable epoxy resin composition having the desired balance of properties for a particular application. For example, the temperature during the mixing of all components may be generally from about 0° C. to about 80° C. in one embodiment, and from about 10° C. to about 40° C. in another embodiment. Lower mixing temperatures help to minimize reaction of the epoxide and hardener in the composition to maximize the pot life of the composition.

The preparation of the curable composition of the present invention, and/or any of the steps thereof, may be a batch or a continuous process. The mixing equipment used in the process may be any vessel and ancillary equipment well known to those skilled in the art.

The process of the present invention includes curing the curable resin composition to form a thermoset or cured product. The curable epoxy resin composition of the present invention provides cured products having flexibility properties.

The process of curing of the curable composition may be carried out at a predetermined temperature and for a predetermined period of time sufficient to cure the composition and the curing may be dependent on the hardeners used in the composition.

For example, the temperature of curing the composition may be generally from about -5° C. to about 200° C. in one embodiment; from about 10° C. to about 190° C. in another embodiment; and from about 20° C. to about 175° C. in still another embodiment.

Generally, the curing time of the curable resin composition may be chosen between about 1 minute to about 24 hours in one embodiment, between about 5 minutes to about 8 hours in another embodiment, and between about 10 minutes to about 4 hours in still another embodiment. Below a period of time of about 1 minute, the time may be too short to ensure sufficient reaction under conventional processing conditions; and above about 24 hours, the time may be too long to be practical or economical.

The epoxy resin cured product (that is, the cross-linked product made from the curable composition) of the present invention shows several improved properties over conventional epoxy resin cured products. For example, the cured product of the present invention may advantageously have a high glass transition temperature (Tg).

For example, the cured product of the present invention exhibits a glass transition temperature generally of between about 20° C. and about 200° C. in one embodiment, between about 30° C. and about 180° C. in another embodiment, and between about 40° C. and about 150° C. in still another embodiment. The Tg of the epoxy resin cured product of the present invention can be measured by the method described in ASTM D 3418 with 10° C. per minute ramp rate.

The cured thermoset produced by the composition of the present invention exhibits excellent properties such as corrosion-resistance, hydrophobicity, flexibility, and/or biodegradability.

The curable composition of the present invention may be used to manufacture a cured thermoset product such as a composite, water membrane potting, infrastructure, adhesive, and the like. For example, the curable composiₜion may be used in applications including electronic applications such as capillary underfill formulations and electrically conductive adhesive formulations. The curable resin composition may be also used as clean reactive diluents for electronic applications, electrically conductive adhesive (ECA) formulations, and for UV cure applications (that is, for example coatings), UV cure formulations for inks and coatings, and laminate applications. Other additional coatings applications may be possible as well.

### EXAMPLES

The following examples and comparative examples further illustrate the present invention in detail but are not to be construed to limit the scope thereof.

Various terms, designations and materials used in the following examples are explained herein below:

“AHEW” stands for Amine Hydrogen Equivalent Weight.

VORAFORCE™ TF303 is a modified epoxy resin having an EEW of about 171 and commercially available from The Dow Chemical Company.

D.E.H™ 641 is a phenalkamine hardener having an AHEW of around 125 and commercially available from The Dow Chemical Company.

Benzyl alcohol is a diluent and commercially available from Hubei Greenhome.

SP-F is a mono-and di-(α-methylbenzyl)phenol, used as an accelerator, and commercially available from Sanko.

“MXDA” is 1,3-benzenedimethanamine, used as a curing agent, and commercially available from Mitsubishi.

Jeffamine D230 is a polyether amine, used as a curing agent, and commercially available from Huntsman.

“AEP” stands for aminoethylpiperazine.

D.E.H. 39 is AEP used as a curing agent and commercially available from The Dow Chemical Company.

“IPDA” stands for isophorone diamine, used as a curing agent, and commercially available from Degussa.

“Ancamine K54” is 2,4,6-tris[(dimethylamino)methyl]-phenol, used as a catalyst, and commercially available from Air Products and Chemicals, Inc.

The following standard analytical equipments and methods are used in the Examples:

Exothenn Release Test for Exothermal Peak Temperature and Reactivity

Exothermic release experiment used in the examples is described in “Exothermic performance and characteristic of the reaction”, UPPC AG of Dow, Version 1.0, 2008; and is used to compare the reactivity of the different epoxy systems. The exothermic release test method can be described as follows:

(1) The sample quantity used in the method should be at least 100 g of VORAFORCE™ TF303 and approximately 100 g of hardener. The measurement is performed on 100 g in total of sample (resin+hardener).

(2) The mix ratio used in the method is based on the following stoichiometric calculation:

AHEW*100/EEW=Weight of Hardener per 100 g Epoxy Resin

(3) The equipment and devices used in the method includes the following:

(i) a lab with temperature control (23±1° C.) and humidity control (50±5%);

(ii) a spatula to stir the resin and hardener;

(iii) a balance with a precision of 0.01 g;

(iv) A 200 ml poly-lining paper cup with the following dimensions:

| | |
|---|---|
| Outside diameter - bottom | 52 mm |
| Outside diameter - top | 75 mm |
| Overall height | 90 mm |

(v) an insulating jar for the paper cup;

(vi) two temperature sensors with two four-channels digital thermometers and K-type thermocouples. The accuracy of the sensors should be at 23±0.5° C. is ±(0.2% reading +1° C.); and

(vii) two test boxes (each with 3 cells).

(4) The procedures used in the method include:

(i) condition the samples in the lab @ 23±1° C. for at least one hour;

(ii) put the paper cup into the insulating jar; weigh the stoichiometric amount of resin into the paper cup; and fill the cup up to 100 g with the stoichiometric amount of hardener;

(iii) after weighing the paper cup with the resin and hardener ingredients, immediately start mixing the resin and hardener in the paper cup for two minutes until a homogeneously mixed system is obtained;

(iv) put the paper cup with the homogeneously mixed system out of the insulating jar, place it into the test box cell under the thermocouples and start recording data; and

(v) repeat the above procedure for the next sample.

“Exothermal release peak temperature” is defined as the highest temperature from the recorded data. The “reactivity” is indicated by the time from the record start point to the highest temperature point. This method is widely used in the epoxy industry as exothermal release and reaction activity test.

The following examples are set forth to illustrate various embodiments of the present invention; and are not intended to limit the scope of the present invention. Unless otherwise stated all parts and percentages in the following examples are by weight.

### Example 1 and Comparative Examples A-D

Several epoxy systems were prepared using the compositions described in Table I. D.E.H™ 641 is synthesize with a cashew nutshell liquid (CNSL) having decarboxylation degree >90%. In Example 1, D.E.H™ 641 is reacted with VORAFORCE™ TF303 while in Comparative Examples A, B, C, and D the curing agents described in Table I are reacted with VORAFORCE™ TF303 in an equal stoichiometric amount.

TABLE I

| | Compar- | Compar- | Compar- | Compar- | |
|---|---|---|---|---|---|
| | ative | ative | ative | ative | |
| | Exam- | Exam- | Exam- | Exam- | Exam- |
| Components | ple A | ple B | ple C | ple D | ple 1 |
| VORAFORCE ™ | 83.3 | 80 | 80 | 74.1 | 57.8 |
| TF303 | | | | | |
| MXDA | 16.7 | | 10 | | |
| IPDA | | 20 | | | |
| Jeffamine | | | 10 | 25.9 | |
| D230 | | | | | |
| D.E.H ™ | | | | | 42.2 |
| 641 | | | | | |

The epoxy system in Example 1 showed an extremely lower exothenn peak temperature (54.4° C.) than the epoxy systems of Comparative Examples A-D. In addition, the epoxy system in Example 1 at the lower exothenn temperature maintained a relative faster reactivity (54.4° C., 150 minutes [min]) than the epoxy systems in Comparative

Example A (231.4° C., 125 min), Comparative Example B (180.9° C., 198 min), Comparative Example C (191.6° C., 247 min), and Comparative Example D (28° C., 900 min).

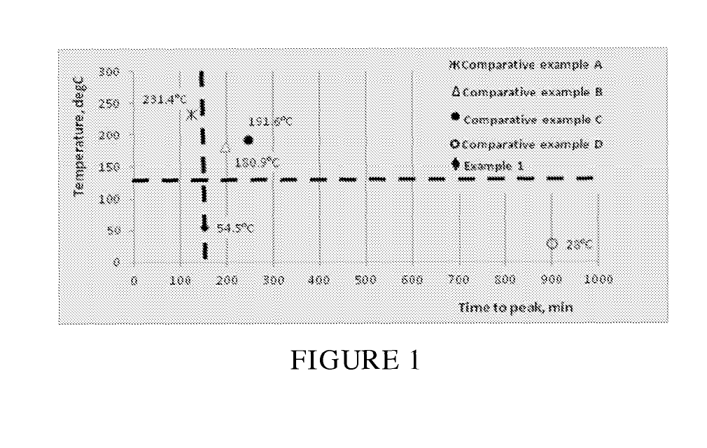

As illustrated in FIG. 1, the peak temperature versus time to peak (reactivity) graph, shows that the epoxy system of Example 1 is located at the bottom left quadrant of the graph which indicates that the epoxy system of Example 1 exhibits a balance of low exotherm (<125° C.) and high reactivity (<150 min) while the epoxy systems of the Comparative Examples A-D are either located at top left quadrant or the bottom right quadrant which indicates that the Comparative Examples do not exhibit a balance of exothenn and reactivity properties.

### Examples 2-4 and Comparative Example E

As described in Table II, the composition in Example 2 contained 10% SP-F and 90% D.E.H.™ 641 as curing agent; the composition in Example 3 contained 10% SP-F, 10% benzyl alcohol and 80% D.E.H.™ 641 as curing agent; and the composition in Example 4 contained 10% SP-F, 10% Benzyl alcohol, 2% D.E.H.™ 39 and 78% D.E.H.™ 641 as curing agent. The composition in Comparative Example E contained 10% DMP-30 and 90% D.E.H.™ 641 as curing agent.

TABLE II

| | | | | | Compar- |
|---|---|---|---|---|---|
| | | | | | ative |
| | Exam- | Exam- | Exam- | Exam- | Exam- |
| Examples | ple 1 | ple 2 | ple 3 | ple 4 | ple E |
| VORAFORCE ™ | 57.8 | 55.25 | 52.36 | 53.5 | 55.25 |
| TF303 | | | | | |
| D.E.H. ™ | 42.2 | 40.275 | 38.112 | 36.27 | 40.275 |
| 641 | | | | | |
| SP-F | | 4.475 | 4.764 | 4.65 | |
| Benzyl Alcohol | | | 4.764 | 4.65 | |
| D.E.H. ™ | | | | 0.93 | |
| 39 | | | | | |
| Exp0154B | | | | | |
| Ancamine | | | | | 4.475 |
| K54 | | | | | |
| Total | 100 | 100 | 100 | 100 | 100 |

The epoxy system in Example 2 showed over 30° C. lower exothenn release peak temperature (92.0° C.) compared to Comparative Example E (126.6° C.), while also faster reactivity (80 min) compared to Comparative Example E (88 min).

The epoxy system in Example 3 showed over 60° C. lower exotherm release peak temperature (89.9° C.) compared to Comparative Example E (126.6° C.), while also faster reactivity (64 min) compared to Comparative Example E (88 min).

The epoxy system in Example 4 showed over 45° C. lower exotherm release peak temperature (109.6° C.) compared to Comparative Example E (126.6° C.), while also faster reactivity (60 min) compared to Comparative Example E (88 min).

The present invention indicated a curing agent composition for epoxy resins, comprising at least one phenalkamine blended with at least one phenol or phenol novolac having at least one alpha-methylbenzyl or alpha,alpha-diinethylbenzyl substituent as an accelerator or a catalyst. The phenalkamines are prepared with CNSL. The curing agent composition of the present invention indicates an extremely low exothenn release peak temperature at ambient temperature while maintaining a high reactivity comparing to other conventional curing agents. The curing agent composition of the present invention can be applied to potting for potting, casting, composite and other applications that require a low exothenn release during reaction.

What is claimed is:

1. A curing agent composition comprising: (a) at least one phenalkamine; and (b) at least one styrenated phenol or styrenated phenol novolac compound.

2. The curing agent composition of claim 1, wherein the phenalkamine comprises a phenalkamine produced from ethylenediamine.

3. The curing agent composition of claim 1, wherein the phenalkamine comprises polymer of cashew nutshell liquid with formaldehyde and ethylenediamine.

4. The curing agent composition of claim 1, wherein the phenalkamine compound comprises a product prepared by a Mannich reaction of cashew nutshell liquid with formaldehyde and a polyamine.

5. The curing agent composition of claim 1, wherein the phenalkamine compound comprises a compound defined by Structure (I) as follows: 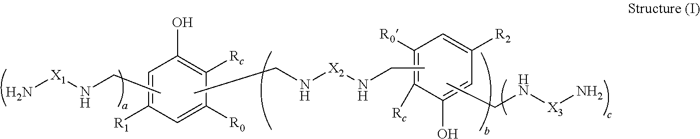
wherein R₀ and R₀′ each can be a straight alkyl with 15 carbons and 0 to 3 C═C bond(s) or a straight alkyl with 17 carbons and 1 to 3 C═C bond(s); R₁ and R₂ each can be hydrogen (—H), hydroxyl (—OH); R_{c} can be hydrogen (—H) or carboxyl (—COOH); a can be 0 to 2; b can be 0 or a natural number less than or equal to 20; c can be 0 or 1; a+b+c≠0; and X₁, X₂, and X₃ each can be a bivalent or multivalent group.

6. The curing agent composition of claim 5, wherein R₀ and R₀′ each can be a straight alkyl with 15 carbons and 0 to 3 C═C bond(s) selected from the group consisting of —C ₁₅H₃₁, —C ₁₅H₂₉, —C₁₅H₂₇, and —C ₁₅H₂₅, or a straight alkyl with 17 carbons and 1 to 3 C═C bond(s) selected from the group consisting of —C₁₇H₃₃, —C₁₇H₃₁, and —C₁₇H₂₉.

7. The curing agent composition of claim 5, wherein X₁, X₂, and X₃ each can be a bivalent or multivalent group selected from the group consisting of an ethylene aliphatic, an amino ethylene, a polyoxyalkylene, acycloaliphatic, an aromatic, and a polycyclic structure.

8. The curing agent composition of claim 1, wherein the at least one styrenated phenol or styrenated phenol novolac compound includes two substances in which a phenol or phenol novolac has at least one alpha-methylbenzyl or alpha,alpha-dimethylbenzyl substituent.

9. The curing agent composition of claim 8, wherein the alpha,alpha-dimethylbenzyl derivative carries one or more t-butyl groups.

10. The curing agent composition of claim 9, wherein the t-butyl groups are introduced by including isobutylene as a reactant in the composition.

11. The curing agent composition of claim 8, wherein the at least one styrenated phenol or styrenated phenol novolac compound is prepared from phenol or phenol novolac by acid-catalyzed alkylation with styrene or alpha-methylstyrene.

12. The curing agent composition of claim 1, wherein the weight ratio of the phenalkamine to the styrenated phenol or styrenated phenol novolac compound is sufficient to form a curing agent composition for an epoxy compound.

13. The curing agent composition of claim 12, wherein the weight ratio of the phenalkamine to the styrenated phenol or styrenated phenol novolac compound is from about 1:1 to about 99:1.

14. The curing agent composition of claim 1, wherein the curing agent composition has an exotherm release peak temperature at ambient temperature of less than about 125° C. while the curing agent composition maintains a reactivity of less than about 150 minutes.

15. A process for preparing a curing agent composition comprising admixing: (a) at least one phenalkamine and (b) at least one styrenated phenol or styrenated phenol novolac compound to form a curing agent composition for an epoxy compound.

16. A curable composition comprising: (I) at least one epoxy compound; (II) at least one phenalkamine, and (III) at least one styrenated phenol or styrenated phenol novolac compound.

17. The curable composition of claim 16, wherein the epoxide compound comprises at least one liquid epoxy resin (LER) component to form the epoxy matrix in a final curable composition.

18. The curable composition of claim 16, including a second curing agent separate and different from compounds (II) and (III), a filler, a reactive diluent, a flexibilizing agent, a processing aide, a toughening agent, or a mixture thereof.

19. A process for preparing a curable composition comprising admixing: (I) at least one epoxy compound; (II) at least one phenalkamine; and (III) at least one styrenated phenol or styrenated phenol novolac compound.

20. A process for preparing a thermoset comprising:
(i) providing a mixture of: (I) at least one epoxy compound; and (II) at least one phenalkamine; and (III) at least one styrenated phenol or styrenated phenol novolac compound; and
(ii) curing the curable composition of step (i).

21. The process of claim 20, wherein the curing step (ii) is carried out at a temperature of from about 15° C. to about 25° C.; and at a relative humidity of 55±5 percent.

22. A cured thermoset article prepared by the process of claim 20.

23. The cured thermoset article of claim 22, wherein the thermoset is a composite.
